(19) United States
(12) Patent Application Publication
(10) Pub. No.: US 2009/0121931 A1
(43) Pub. Date: May 14, 2009

(54) Wrist Worn Communication Device coupled with Antenna Extendable by the Arm

(76) Inventor: Daniel A. Katz, Kiryat Ono (IL)

Correspondence Address: DANIEL KATZ, 87 TZAHAL ST., KIRYAT-ONO, 55451, IL

(21) Appl. No.: 11/938,311

(22) Filed: Nov. 12, 2007

(51) Int. Cl. G01S 1/04; H04B 7/185

(52) U.S. Cl. 342/357.09; 342/385; 342/352; 342/350

(57) ABSTRACT

The present invention discloses a wrist-worn wireless communication device coupled with an RF antenna configured to operate folded or coiled in the device, or extended along the arm from wrist to elbow. A typical embodiment of the invention relates to an emergency radio beacon, particularly for satellite based systems such as a Personal Locator Beacon (PLB) for the Cospas-Sarsat system.

### BACKGROUND OF INVENTION

It is well known in the art that efficient RF communications depend on, among other factors, a matched antenna, usually ¼ or ½ of the transmission wavelength (“lambda”) long. For example, a 406 MHz radio transmits at a wavelength of approximately 74 cm, so a compatible ½ lambda antenna is approximately 37 cm long and a compatible ¼ lambda antenna for that radio is about 18 cm long.

Obviously, too long antennas are not desirable due to many reasons such as: installation and maintenance cost, being an obstacle to traffic, danger to public safety, environmentally unfriendly, etc. In particular, long antennas dissatisfy mobile applications, particularly inconvenient for portable use. However, frequency allocation might often prefer or enforce relatively low frequencies, i.e. long antennas, due to other reasons such as: better RF propagation, less noise and interference, regulations etc.

For example, frequencies reserved for emergency communications for aircraft in distress are 121.5 MHz for civilian use, also known as International Air Distress (IAD) and 243 MHz for military use, also known as Military Air Distress (MAD). Both are in use at the international level and are monitored by aircraft and ground stations worldwide. A ½ lambda antenna for 121.5 MHz is about 123 cm long and it is quite inconvenient to carry and operate a personal distress device coupled with a 123 cm antenna, specifically if it has to be done while conducting other activities, such as walking in a forest, swimming, rowing a canoe or a kayak, etc.

A particular case where long antennas are significantly disadvantageous is with worn or wearable communication devices. Applying an efficient antenna to wearable devices is challenging due to the human body shape, its dimensions and its interference with RF radiation. Clearly, for ergonomic reasons, such an antenna should limit the users activity and functioning as less as possible.

Another communication application disturbed by long antennas is Search and Rescue (SAR). SAR devices are often been carried by users involved in extreme and demanding activities such as ski, hiking, climbing, hunting, rowing, sailing and so on. In case of emergency, such as an injury or sudden illness or boat capsizing/sinking, or any other accident, a handy emergency radio beacon can make the difference between live and death. However, carrying such a radio beacon, continuously, while skiing or hiking or climbing or rowing, might be troublesome if attached with a long antenna.

While some SAR devices are transponders, always ready to answer an interrogation, others are active, operating only upon distress, either manually or automatically triggered. Such distress/emergency radio beacons are most of the time turned off and obviously, when not active, there is no importance to the antenna position and size, from the communication aspect. Therefore, in the non active mode, the antenna might better be folded or coiled in a way that it does not disturb the user's activity.

A particularly interesting case in the scope of the present invention is with personal distress radio beacons operating in VHF/UHF bands. Such devices require relatively long antennas, yet been carried or worn during extreme activities, so long antennas might significantly disturb.

Another particularly interesting application relevant to the present invention relates to the marine accident known as Man over Board (MOB). Hundreds and thousands of persons are lost every year all around the world after falling off board vessels in the open sea. Yachtsmen, cruising passengers, fishermen, mercantile ships sailors, occasionally and accidentally fall overboard. These situations become particularly difficult to deal with as they occur far away offshore, in hostile environmental conditions, with limited local resources for treatment. Detection and location of a person that falls from a vessel at sea is crucial since survival time in water is limited, typically 2-40 hours at 60-70° F. (16-21° C.) and 1-6 hours at 40-60° F. (4-16° C.). A wearable emergency beacon can significantly help in MOB accidents, when such a device can alert ships' crew persons or shore stations or dedicated SAR teams, communicating the distress either by direct transmission or via satellites. Yet, it's quite impractical to request every person onboard to continuously carry a device coupled with a relatively long extended antenna. It can disturb pulling a net or hoisting a sail or drinking a martini, thus many sailors might avoid carrying it and consequently endanger themselves.

The use of satellites to detect and locate emergency radio beacons dramatically reduces the time required to alert the appropriate authorities and to accurately locate the distress site by the rescue team.

A particular and important type of a satellite based SAR system is Cospas-Sarsat., established by the USA, Canada, France and Russia (the Soviet Union) and operational from 1982. Since then, the system has been used for thousands of SAR events and has been instrumental in the rescue of over 20,000 lives worldwide.

Cospas-Sarsat is a satellite system designed to provide distress alert and location data to assist SAR operations, using spacecraft and ground facilities to detect and locate the signals of distress radio beacons operating on 406 MHz (and 121.5 MHz until 2009) all over the world. The position of the distress is determined either by the Doppler shift of the radio beacons transmission or by the position data embedded in the beacon's message, in case that a navigation receiver (such as GPS, GLONASS, or Galileo) is comprised in the radio beacon. The emergency radio beacon location and other related information is forwarded to the appropriate shore station through the Cospas-Sarsat space and terrestrial network. The goal of the System is to support all organizations in the world with responsibility for SAR operations, whether at sea, in the air or on land. A detailed description of the Cospas-Sarsat System is provided in the document entitled “Introduction to the Cospas-Sarsat System, C/S G.003”—http://cospas-sarsat.org/Documents/gDocs.htm

The International Maritime Organization (IMO) and the International Civil Aviation Organization (ICAO) recommend that ships and aircraft carry Emergency Position Indicating Radio Beacons (EPIRBs) and Emergency Locator Transmitters (ELTs) respectively. Recently, small size Personal Locator Beacons (PLBs) are getting more and more popular for terrestrial use, by hikers, skiers, hunters and travelers. In addition, mariners and seafarers might find very helpful to wear a personal radio beacon to alert MOB.

The current invention is particularly applicable to Cospas-Sarsat PLBs worn by mariners to alert MOB; however reference to Cospas-Sarsat or to the specific application of MOB herein is intended to encompass any similar system or application, currently operating or to be deployed in the future.

U.S. Pat. No. 5,852,401 to Kita (Casio), discloses a wristwatch type distress message sending device worn by the user. The device comprises a GPS receiver, some sensors, distress signal generating means and a radio for sending the distress signal. The radio sending antenna is a helical antenna contained in the body. In addition, a helical whip antenna may be provided so as to extend from the watch body for sending/receiving purposes.

As discussed before, such a design might be impractical in case of relatively long VHF or UHF antennas, disturbing or limiting the user during outdoor activities. An antenna contained in a wristwatch type device usually lacks the efficiency of a longer unfolded antenna, while a whip antenna extended from the watch body, without any means of support, might be easily damaged.

U.S. Pat. No. 4,673,936 to Kotoh (Mitsubishi), discloses a small-size transmitting apparatus for search and rescue operation (SARTR) adapted to be worn by a user for emitting a microwave rescue signal upon a marine accident involving the user.

Since it operates on microwaves, with a typical ½ lambda less than 2 cm, design considerations relevant to VHF/UHF are not applicable here and antennas of 20-40 cm long are not considered in that invention.

U.S. Pat. No. 7,251,197 to Yoshida et al. (Casio), discloses a wrist-worn communications device coupled to a wrist band with an extendable antenna.

Yet, this antenna is housed within a lid in the wrist band (not in the device itself), is extendable towards the palm (not in the direction of the elbow), is not flexible and is provided with no further support to the arm or elbow.

U.S. Pat. No. 5,559,760 to Schneider (Breitling), discloses a wristwatch comprising, in addition to a device for measuring and displaying the time, a high-frequency transmitter and an extensible antenna in the form of a wire wound up in a housing of the watch before use, one of whose ends is fastened to the watch, the other end being secured to a plug removably fastened to the watch before use of the transmitter, the antenna being unfurled by pulling on the plug, this unfurling moreover having the effect of closing the switch and turning on the transmitter and a counterpoise antenna of the same type as the main antenna and also wound up, before use, in a housing of the watch and one end of which being also secured to a plug removably fastened to the watch before use, said counterpoise antenna being arranged in such a way as to be able to be unfurled in a direction opposite to that of the main antenna.

This invention uses a double ended antenna configured that once been extended, does not flex but remains straight. Such a design might be problematic with some activities done by the user after activating the device, such as swimming or climbing or skiing.

U.S. Pat. No. 6,987,708 to Megner et al., discloses an emergency call transmitter adapted to be attached in a threaded recess of a wristwatch housing, the call transmitter comprising a transmitter housing carrying an emergency signal-emitting mechanism, the housing having an external screw thread formed thereon. Possibly, said signal-emitting mechanism includes an extractable antenna.

This invention, based on a wristwatch housing, claims for an extractable antenna however does not elaborate on that and does not mention any support or attaching facility to the extractable antenna.

The present art methods described above have not yet provided satisfactory solutions to the problem of using a wrist-worn communication device with an electrically efficient antenna yet not disturbing the user's activities such as swimming, skiing, climbing, rowing, etc.

It is the object of the present invention to provide a device and method for a wrist-worn wireless communication device coupled with an efficient RF antenna yet not disturbing users' activities such as swimming, skiing, climbing, rowing, etc

It is another object of the present invention to provide a device and method for a wrist-worn wireless communication device, configured to transmit automatically from time to time, wherein the user is been indicated that the transmitter is about to be activated within some seconds, so he could be able to improve his position and increase communications success probability.

It is yet another object of the present invention to provide a device and method for a wrist-worn emergency radio beacon, such as PLB or EPIRB or ELT or SSAS, particularly compatible with satellite systems such as COSPAS-SARSAT, coupled with an efficient antenna yet not disturbing user's activities such as swimming, skiing, climbing, rowing, etc

It is yet also an object of the present invention to provide a device and method for a wrist-worn wireless communication device operating on VHF/UHF bands, such as 406 MHz, 121.5 MHz and 243 MHz, provided with an efficient RF antenna and limiting as less as possible the users activities and functioning.

It is also an object of the present invention to provide a device and method for a wrist-worn device comprising also a positioning/navigation receiver, such as GPS or Galileo, configured to provide the device's self position in terms of geographical coordinates, to be embedded it in the message that the device transmits.

It is yet an object of the present invention to provide a device and method for a wrist-worn device wherein said wireless communication device comprises also a user interface indication for acknowledging the transmission, configured to signal the user that one of his previous transmissions has been received properly.

It is also an object of the present invention to provide a device and method for a wrist-worn distress radio beacon, wearable by a person onboard a vessel and used for MOB alert.

### SUMMARY OF INVENTION

The present invention discloses a device and a method for a wrist-worn wireless communication device coupled with an RF antenna, said antenna configured to operate folded or coiled in said wrist-worn device, or extended along the arm from wrist to elbow, wherein said antenna is made of a flexible electrical conductor and is provided with means for been attached along the arm or by the elbow, comprised of:

a) A wrist-worn housing;
b) At least one of the following, in said housing: i) an RF transmitter; ii) an RF receiver;
c) An RF antenna, coupled to said RF transmitter and/or RF receiver, said antenna configured to be placed at least in the following positions: i) folded or coiled in said housing; ii) extracted from said housing and attached along the arm and/or by the elbow.
d) Means to attach the extracted antenna along the arm or by the elbow.

In a preferred embodiment, said wireless communication device comprises also:

e) A micro controller, configured to activate the transmitter automatically from time to time;
f) A user interface for transmission indication, wherein said transmission indication is either audible or visible or touchable (e.g. vibrating), or a combination thereof, wherein said transmission indicator configured to signal the user in a pre-defined manner that the transmitter is about to be activated within some seconds.

In this preferred embodiment, said wrist-worn communication device is an emergency radio beacon used for Search and Rescue (SAR) of its user, also known as a Personal Locator Beacon (PLB), compatible with the COSPAS-SARSAT satellite system. This PLB comprises a UHF (406 MHz) transmitter, and comprises in addition: g) a GPS receiver configured to provide the device's self position in terms of geographical coordinates, to be embedded in the message that the device transmits.

In this preferred embodiment, the wrist-worn PLB transmits automatically, upon switching on, every 50 seconds, a digital message for approximately 0.5 seconds, according to the COSPAS-SARSAT protocol. The transmission indicator of the device is a led, configured to: i) blink (on for 250 msec; off for 250 msec; and so on, periodically) for 10 seconds before each transmission; ii) turn on when the device is actually transmitting; iii) turn off for the rest of the time.

In this preferred embodiment, the wrist-worn PLB is a waterproof device, wearable by a person onboard a vessel and when said person falls overboard, said antenna is configured to be extracted and fixed along the arm or by the elbow. When the antenna is completely out, a further slight pull switches the emergency transmitter on. Alternatively, the device is turned on when the user starts to extract the antenna, pulling a mechanical safety latch and closing an electrical circuit.

Then, within less than a minute, the transmission led starts blinking, indicating that the device is turned on, and that the transmitter is about to be activated, enabling the user to improve his position (particularly pull his arm high out of the water) in order to achieve better communication conditions.

In the following years, it is planned that COSPAS-SARSAT payloads carried onboard Galileo satellites, will acknowledge compatible 406 MHz distress signals. The present invention will then benefit from that feature, as the acknowledgement of a distress signal will be indicated to the user, and hopefully improve his morale and survival odds. Furthermore, such an acknowledgement can let the person in distress be less worried about positioning himself to transmit the distress signal efficiently, and pay more attention to other factors to survive.

Other objects and advantages of the invention will become apparent as the description proceeds.

### BRIEF DESCRIPTION OF DRAWINGS

The above and other characteristics and advantages of the invention will be better understood through the following illustrative and non-limitative detailed description of preferred embodiments thereof, with reference to the appended drawings, wherein:

FIG. 1 shows an overview of a wrist-worn communication device coupled with antenna extendable by the arm, in the environment of COSPAS-SARSAT and GPS satellites.

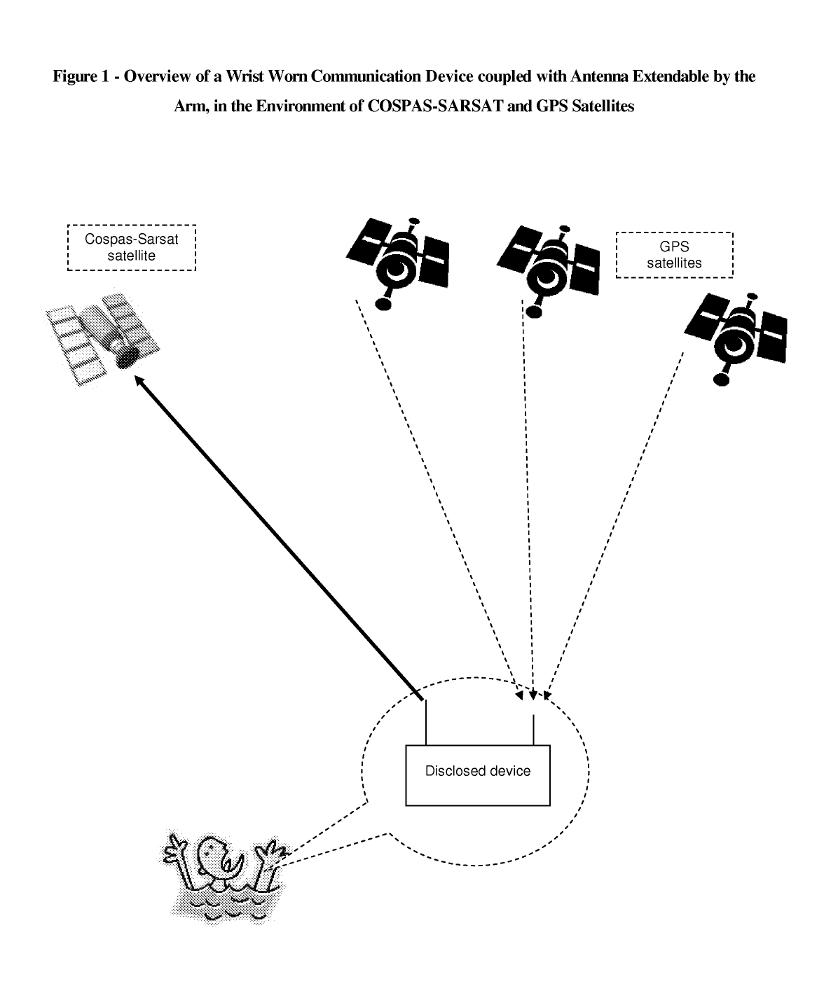

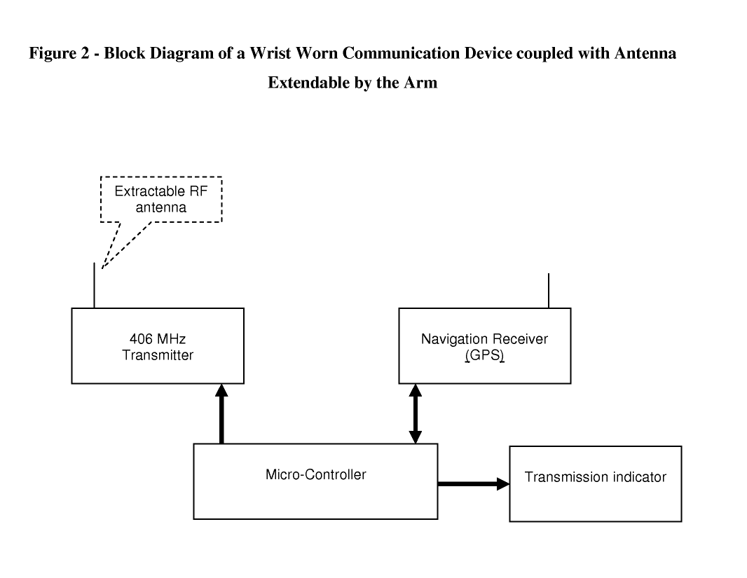

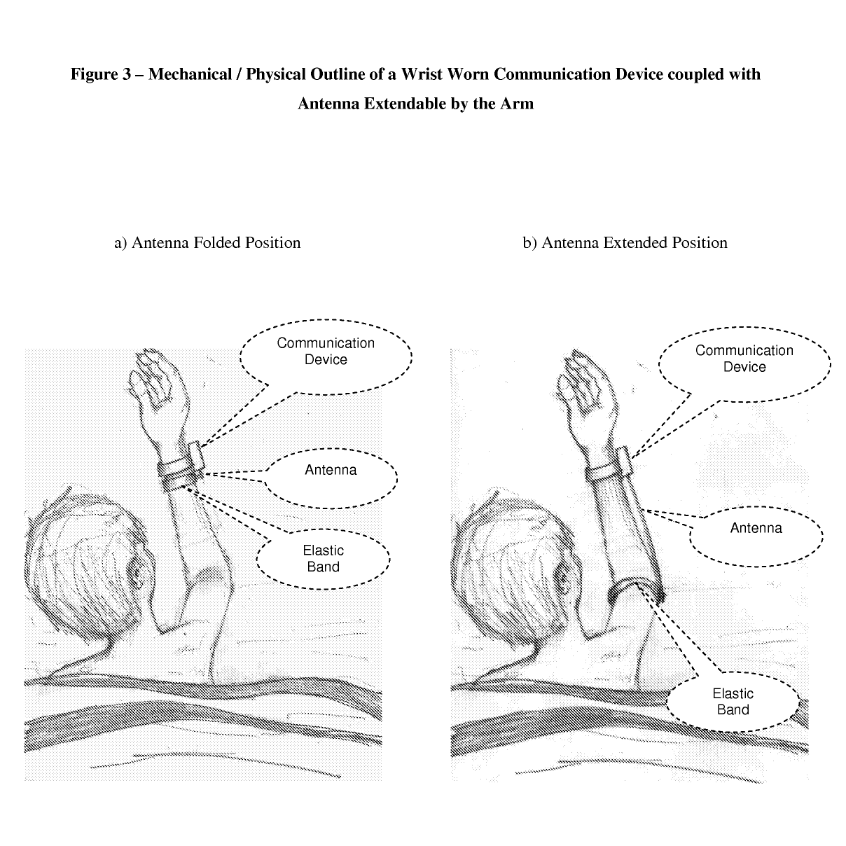

This figure shows: a) three GPS satellite; b) one Cospas-Sarsat satellite; c) the disclosed device worn on a user's wrist.

The disclosed device, in its preferred embodiment, obtains two antennas: a GPS antenna (L band) configured to receive GPS satellites signals and a UHF (406 MHz) antenna, used to transmit alarm signals to Cospas-Sarsat satellites. In order to fix a position, signals from at least three GPS satellites should be simultaneously received (if the altitude is known as on sea level) but four satellites guarantee a position fix in any case, and more in-view satellites can refine accuracy. For distress signaling purposes, one Cospas-Sarsat satellite is sufficient. The preferred embodiment of the disclosed device comprises a GPS receiver and embeds its self position in the alarm message, so any Cospas-Sarsat satellite (LEO, GEO and also MEO in due time) can be used in conjunction.

FIG. 2 shows a block diagram of a preferred embodiment of a wrist-worn communication device coupled with antenna extendable by the arm.

This figure shows four main blocks: a) a UHF (406 MHz) transmitter coupled with an extractable antenna; b) a navigation (GPS) receiver including antenna; c) a microcontroller; d) a transmission indicator, which is a led in the preferred embodiment. All said four blocks can be implemented by off the shelf components well known in the art.

FIG. 3 shows a mechanical/physical outline of a preferred embodiment of a wrist-worn communication device coupled with antenna extendable by the arm.

The figure shows the disclosed device worn on a wrist, in the following positions: a) antenna folded/coiled inside the housing; b) antenna extended by the arm and attached to the elbow by an elastic band.

### DETAILED DESCRIPTION

The present invention discloses a device and a method for a wrist-worn wireless communication device coupled with an RF antenna, said antenna configured to operate folded or coiled in said wrist-worn device, or extended along the arm from wrist to elbow, wherein said antenna is made of a flexible electrical conductor and is provided with means for been attached along the arm or by the elbow, comprised of:

a) A wrist-worn housing;
b) At least one of the following, in said housing: i) an RF transmitter; ii) an RF receiver;
c) An RF antenna, coupled to said RF transmitter and/or RF receiver, said antenna configured to be placed at least in the following positions: i) folded or coiled in said housing; ii) extracted from said housing and attached along the arm and/or by the elbow.
d) Means to attach the extracted antenna along the arm or by the elbow.

In a preferred embodiment, said wireless communication device comprises also:

e) A micro controller, configured to activate the transmitter automatically from time to time;
f) A user interface for transmission indication, wherein said transmission indication is either audible or visible or touchable (e.g. vibrating), or a combination thereof, wherein said transmission indicator configured to signal the user in a pre-defined manner that the transmitter is about to be activated within some seconds.

The microcontroller is selected from the IT MSP430 single chip microcontroller family. For a brochure see—http://focus.ti.com/lit/ml/slab0341/slab0341.pdf

The transmission indicator of the device is a LED, driven by the micro controller, configured to: i) blink (on for 250 msec; off for 250 msec; and so on, periodically) for 10 seconds before each transmission; ii) turn on when the device is actually transmitting; iii) turn off for the rest of the time.

In this preferred embodiment, said wrist-worn communication device is an emergency radio beacon used for Search and Rescue (SAR) of its user, also known as a Personal Locator Beacon (PLB), compatible with the COSPAS-SARSAT satellite system. This PLB comprises a UHF (406 MHz) narrowband (3 KHz) transmitter, tunable over the 406.0-406.1 MHz band to any center frequency at 1 KHz resolution, and coupled with a PSK modulator. The RF antenna is ¼ lambda, about 18 cm long, while the ocean is used as a reflective ground plane, in this preferred embodiment. The antenna is made of a flexible yet strong conductive wire, coiled inside the housing. On one end the antenna is coupled to the transmitter and on the other end it is accessible by the user, connected to an elastic band, such as a rubber “O” ring, wearable on the wrist, between the device housing and the elbow. The antenna can be extracted from its housing, extended along the arm and be fixed to the elbow by means of the elastic band which is moved from the wrist and placed beyond the elbow. When the antenna is completely out, a further slight pull switches the emergency transmitter on. Alternatively, the device is turned on when the user starts to extract the antenna, pulling a mechanical safety latch and closing an electrical circuit.

In the preferred embodiment, the device also comprises: g) a GPS receiver configured to provide the device's self position in terms of geographical coordinates, to be embedded in the message that the device transmits.

The GPS receiver is based on u-blox UBX-G5010 GPS single chip. For a data sheet see—http://www.u-blox.com/products/ubx-g5010.html

In this preferred embodiment, the wrist-worn PLB transmits automatically, after switched on, a digital message every 50 seconds, for approximately 0.5 seconds, according to the Cospas-Sarsat protocol. This digital message includes, among other data, the device unique Identification number (ID) and the actual position of the device provided by the GPS receiver.

The technical specifications that define the Cospas-Sarsat radio beacon, including RF characteristics, modulation and protocol (including message format), are detailed in the following document:

### SPECIFICATION FOR

### COSPAS-SARSAT

### 406 MHz DISTRESS BEACONS

### C/S T.001

### Issue 3-Revision 7

### Nov. 2005

Which can be found at—http://www.cospas-sarsat.org/DocumentsTSeries/T1Nov05.pdf

According to one aspect of the invention, the presently disclosed device is a waterproof wrist-worn PLB, wearable by a person onboard a vessel; when said person accidentally falls overboard, he extracts the antenna out of its housing, and fixes it along the arm, placing the elastic band to support the antenna beyond his elbow. When the antenna is completely out, a further slight pull switches the emergency transmitter on. Then, within less than a minute, the transmission led starts blinking, indicating that the device is turned on, OK, and that the transmitter is about to be activated, then the led stays on when the device is actually transmitting. The person over board carefully monitors the transmission LED and when it starts blinking, he keeps his arm extended upwards out of the water for about 15 seconds in order to assure optimal transmission conditions. This process may be repeated several times.

According to another aspect of the invention, the presently disclosed device is a wrist-worn PLB, worn by a skier or a hiker or a hunter or a canoe/kayak rower. When said person is in distress, he extracts the antenna out of its housing, and fixes it along the arm, placing the elastic band that is fastened to the antenna beyond his elbow. The device is turned on when the user starts to extract the antenna, pulling a mechanical safety latch and closing an electrical circuit. Then, the person in distress carefully monitors the transmission LED and when it blinks, he places himself in the best possible transmission position, typically rising his arm upwards to the zenith keeping away from any obstacle that might prevent a line of sight (LOS) with the satellites, such as buildings, vehicles, trees, boulders, ice walls and so on. If preferred, the person can continue skiing, rowing, walking, etc., not bounded and not bothered by the wrist-worn device and its extended antenna.

The above examples and description have of course been provided only for the purpose of illustration, and are not intended to limit the invention in any way. As will be appreciated by the skilled person, the invention can be carried out in a great variety of ways, employing more than one technique from those described above, all without exceeding the scope of the invention. In this context, though the invention specifically refers to the Cospas-Sarsat system, it is definitely not bounded to this particular system, and its scope is well beyond any specific satellite communication or navigation system or any specific radio beacon type or system.

The invention claimed is:

1. A device and a method for a wrist-worn wireless communication device coupled with an RF antenna, said antenna configured to operate folded or coiled in said wrist-worn device, or extended along the arm from wrist to elbow, wherein said antenna is made of a flexible electrical conductor and is provided with means for been attached along the arm or by the elbow, comprised of:
a) A wrist-worn housing;
b) At least one of the following, in said housing: i) an RF transmitter; ii) an RF receiver;
c) An RF antenna, coupled to said RF transmitter and/or RF receiver, said antenna configured to be placed at least in the following positions: i) folded or coiled in said housing; ii) extracted from said housing and attached along the arm and/or by the elbow.
d) Means to attach the extracted antenna along the arm or by the elbow.

2. A device and method according to claim 1, wherein said wireless communication device comprises also a micro controller configured to activate the transmitter automatically from time to time.

3. A device and method according to claim 2, wherein said wireless communication device comprises also a user interface for transmission indication, wherein said indication is either audible or visible or touchable, or a combination thereof, wherein said transmission indicator configured to signal the user in a pre-defined manner that the transmitter is about to be activated within some seconds.

4. A device and method according to claim 2, wherein said wireless communication device is an emergency radio beacon used for Search and Rescue (SAR) of its user, such as but not restricted to: a Personal Locator Beacon (PLB); an Emergency Position Indicating Radio Beacon (EPIRB); an Emergency Locator Transmitter (ELT); a Ship Security Alert System (SSAS).

5. A device and method according to claim 2, wherein said wireless communication device is a satellite radio beacon, such as but not restricted to: a COSPAS-SARSAT compatible radio beacon.

6. A device and method according to claim 1, wherein said antenna is tuned to operate in the VHF or UHF band.

7. A device and method according to claim 1, wherein said antenna is tuned to operate in at least one of the following frequency bands: 406 MHz; 121.5 MHz; 243 MHz.

8. A device and method according to claim 2, wherein said wireless communication device comprises also a positioning/navigation receiver, such as GPS or Galileo, said positioning/navigation receiver is configured to provide the device's self position, in terms of geographical coordinates, wherein said self position is configured to be embedded in the message that the device transmits.

9. A device and method according to claim 2, wherein said wireless communication device comprises also a user interface indication for acknowledging the transmission, wherein said indication configured to signal the user that one of his previous transmissions has been received properly.

10. A device and method according to claim 1, wherein said wireless communication device is wearable by a person onboard a vessel and when said person falls overboard, said antenna is configured to be extracted and fixed along the arm or by the elbow, either manually or automatically, and said communication device is configured to transmit emergency signals.
